(19) United States
(12) Patent Application Publication
(10) Pub. No.: US 2016/0318766 A1
(43) Pub. Date: Nov. 3, 2016

(54) High Monolayer Yield Graphene and Methods for Making the Same

(71) Applicant: Thanasis GEORGIOU, Manchester (GB)

(72) Inventor: Thanasis GEORGIOU, Manchester (GB)

(21) Appl. No.: 14/698,877

(22) Filed: Apr. 29, 2015

(51) Int. Cl. C01B 31/04; C25B 1/00

(52) U.S. Cl. CPC C01B 31/0476; C25B 1/00; C01B 2204/32

(57) ABSTRACT

A method of making graphene powders by electrochemical exfoliating graphite contains steps of: A. Fabricating a plurality of graphene rods and B. Electrochemical exfoliating the plurality of graphite rods. In step of A includes sub steps of: a1. Mixing vein graphite with polymer binder; a2. Compressing with a mould to prepare the plurality of graphite rods; and a3. Annealing at 500 C to graphitize remove the polymer binder from the plurality of graphite rods. In step of B. includes sub steps of: b1. Mounting electrodes on plural chips; b2. Adding electrolyte and applying 10V between the plurality of graphite rods and a conductive cathode on the plural chips for 1 hour; and b3. Filtering and repeatedly washing powders on the plurality of graphite rods with water and an organic solvent, and then drying the powders, thus producing graphene powders with preferably high monolayer yield.

### FIELD OF THE INVENTION

The present invention relates to a method of making graphene powders by electrochemical exfoliating graphite which produces the graphene powders easily and quickly

### BACKGROUND OF THE INVENTION

Graphene materials have been at the center of large focus in the recent years because of graphene's exceptional properties. Graphene has a unique range of properties, ranging from record electrical conductivity, thermal conductivity, mechanical stability and others. As a result, a variety of applications are envisaged in the coming years.

Graphene has the highest Young modulus of any material in the world. This means that it is possible to reinforce common polymers with it. Furthermore, although one monoatomic layer of graphene is absorbs just 2.3% of light and remains very conductive. As a result the material is widely believed to replace indium-tin oxide in transparent conductive electrode applications.

Graphene also has extremely large surface area. As a result, it can find application in the field of absorbing salts and/or oils as well as utilizing its large surface area in energy storage devices such as batteries and supercapacitors. Graphene has also record thermal conductivity, which means it will find use in thermal management applications.

As such, mass production of high-quality graphene sheets is essential for their practical application in a variety of field including electronics, optoelectronics, composite materials, and energy-storage devices. A conventional exfoliation of graphite into graphene in aqueous solutions of inorganic salts is disclosed by Khaled Parvez et al in Journal of the American Chemical Society. Khaled Parvez et al report a prompt electrochemical exfoliation of graphene sheets into aqueous solutions of different inorganic salts ((NH4)2SO4, Na2SO4, K2SO4, etc.). Exfoliation in these electrolytes leads to graphene with a high yield (>85%, ≦3 layers), large lateral size (up to 44 μm), low oxidation degree (a C/O ratio of 17.2), and a remarkable hole mobility of 310 cm2 V−1 s−1. Further, highly conductive graphene films (11 ω sq−1) are readily fabricated on an A4-size paper by applying brush painting of a concentrated graphene ink (10 mg mL−1, in N,N′-dimethylformamide). All solid-state flexible supercapacitors manufactured on the basis of such graphene films deliver a high area capacitance of 11.3 mF cm−2 and an excellent rate capability of 5000 mV s−1. The described electrochemical exfoliation shows great promise for the industrial-scale synthesis of high-quality graphene for numerous advanced applications.

However, the production of the above material has two distinct disadvantages. First, the process relies on the use of graphite foil as a parent material which is very expensive compared to cost of graphite. Second, the monolayer content has a wide distribution consisting of 40% monolayer, 40% two-layer and 15% tri-layer. Preferably, a predominantly monolayer distribution of thickness is desired where monolayer accounts for more than 90% of the flakes. The present invention has arisen to mitigate and/or obviate the afore-described disadvantages.

### SUMMARY OF THE INVENTION

The primary objective of the present invention is to provide a method of making graphene powders by electrochemical exfoliating graphite which produces the graphene powders easily and quickly.

To obtain above objectives, a method of making graphene powders by electrochemical exfoliating graphite contains steps of:

A. Fabricating a plurality of graphene rods which includes sub steps of:

a1. Mixing vein graphite with polymer binder;

a2. Compressing with a mould to prepare the plurality of graphite rods; and

a3. Annealing at 500 C to graphitize remove the polymer binder from the plurality of graphite rods;

B. Electrochemical exfoliating the plurality of graphite rods which includes sub steps of:

b1. Mounting electrodes on plural chips;

b2. Adding electrolyte and applying 10V between the plurality of graphite rods and SS cathode on the plural chips for 1 hour; and

b3. Filtering and repeatedly washing powders on the plurality of graphite rods with water and IPA, and then drying the powders, thus producing graphene powders.

Preferably, in a sub step of a2, the plurality of graphite rods is compressing with the mould under 12 tn pressure.

Preferably, in a sub step of b1, multiple graphite rods can be arranged.

Preferably, in a sub step of b2, the electrolyte is 0.1M S₂O₈

### BRIEF DESCRIPTION OF THE DRAWINGS

These and other features, aspects, and advantages of the present invention will become better understood with regard to the following description, appended claims, and accompanying drawings where:

FIG. 1 is an optical image of a material on an oxidized silicon substrate of a method of producing a graphene in an electrochemical cell according to a preferred embodiment of the present invention.

FIG. 2 is a diagram showing the height profile of graphene flakes measured by Atomic Force Microscopy. The height corresponds to 1 layer of graphene.

FIG. 3 is a diagram showing the material of the method of producing the graphene in the electrochemical cell being then pushed through appropriate membranes to prepare free-standing graphene paper according to the preferred embodiment of the present invention.

FIG. 4 is a diagram view showing Raman spectrum of a material of a method of producing graphene in an electrochemical cell according to another preferred embodiment of the present invention.

FIG. 5 is a diagram showing the morphology of graphene paper with a scanning electron microscope (SEM).

FIG. 6 is a diagram showing a sub step a1 in Step A of a method of making graphene powders by electrochemical exfoliating graphite according to a preferred embodiment of the present invention.

FIG. 7A is a diagram showing a sub step a2 in the Step A of a method of making graphene powders by electrochemical exfoliating graphite according to a preferred embodiment of the present invention.

FIG. 7B is a diagram showing the sub step a2 in the Step A of the method of making graphene powders by electrochemical exfoliating graphite according to the preferred embodiment of the present invention.

FIG. 8 is a diagram showing a sub step a3 in the Step A of the method of making graphene powders by electrochemical exfoliating graphite according to the preferred embodiment of the present invention.

FIG. 9 is a diagram showing a sub step b1 in Step B of the method of making graphene powders by electrochemical exfoliating graphite according to the preferred embodiment of the present invention.

FIG. 10 is a diagram showing a sub step b2 in the Step B of the method of making graphene powders by electrochemical exfoliating graphite according to the preferred embodiment of the present invention.

FIG. 11 is a diagram showing a sub step b3 in the Step B of the method of making graphene powders by electrochemical exfoliating graphite according to the preferred embodiment of the present invention.

### DETAILED DESCRIPTION OF THE INVENTION

The present invention will be described with reference to illustrative embodiments. For this reason, numerous modifications can be made to these embodiments and the results will still come within the scope of the invention. No limitations with respect to the specific embodiments described herein are intended or should be inferred.

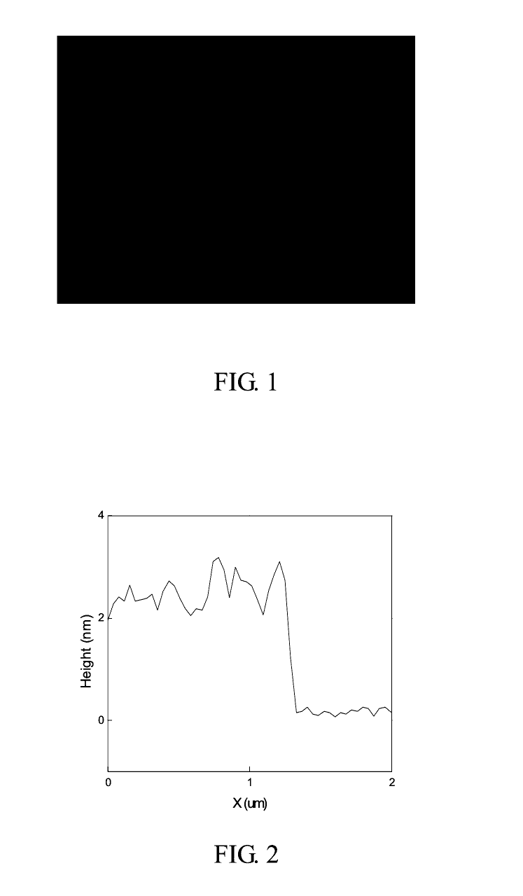

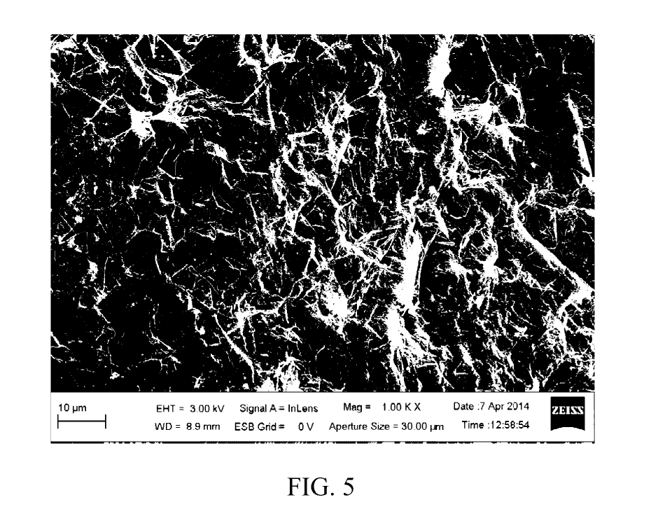

With reference to FIGS. 1 to 5, a method of producing graphene in an electrochemical cell according to a preferred embodiment of the present invention comprises steps of:

A. providing an electrochemical cell with a first graphitic electrode and a second conductive electrode, wherein the first graphitic electrode is made of any one of HOPG, natural graphite, and synthetic graphite, the first graphitic electrode is held at a most positive potential, and the second conductive electrode is conductive.

B. providing an electrolyte of a solvent in the electrochemical cell, wherein the electrolyte has specific oxygen to produce graphene in the electrochemical cell.

Regarding electrodes of the electrochemical cell, the first graphitic electrode is a graphitic material. In one embodiment, high-quality crystalline may be used, in other embodiment partially exfoliated graphite may be used. In some embodiments, graphite already intercalated with salts may be used.

In some embodiments, the first graphitic electrode is contained within a plastic mesh. This facilitates the exfoliated particles to remain in proximity of the first graphitic electrode and in close electrical contact with it for both further exfoliation and oxidation.

The second conductive electrode can be any material known in those skilled in the art as it does not play an important role in the process. Graphite, stainless steel or any conductive material polymer that is compatible with the solvents, electrolyte may be used. In one embodiment, both the first electrode and the second conductive electrode are graphitic and their voltage are alternated between the first graphitic electrode and a second graphite electrode resulting in oxidation and exfoliation of both the first and second graphitic electrodes. As for the electrolyte, it consists of ions in a solvent. The ions result from oxygen-containing anions. Preferable are nitrate, perchlorate, sulfrate, persulfate and phosphate anions. Nitrites, Sulfites, chlorites and phosphites may also be used in one embodiment, the electrolyte may contain a single oxygen-containing atom and in another embodiment it may contain a combination of two or more.

The counterions (i.e., cations) play no important role in the process and can be selected from a variety of elements including, but not limited to, lithium, sodium, potassium, ammonium, magnesium, copper, lead, cadmium, strontium, nitronium, silver caesium, barium, aluminium and others.

The solvent which can be used include any organic solvent or other solvent in which the electrolyte salts are highly soluble. Favorable solvent include but are not limited to: water or organic solvents, including but not limited to acetone, isopropanol, DMSO and others.

In addition, a working potential of the electrochemical cell will be that requiring the oxidation and exfoliation of the first graphitic electrode. In one embodiment, where a reference is included in the electrochemical cell, the voltage is adjusted slightly above this potential. In another embodiment, where the electrochemical cell only comprises by a single electrode an overpotential is applied which may be 10V, 15V, 20V or 30V. The voltage may be kept constant or may be swapped to facilitate exfoliation at both electrodes.

The electrochemical cell is operated at a temperature which achieves the correct level of oxidation and exfoliation. In one embodiment, the electrochemical cell temperature is adjusted to allow for maximum exfoliation and of the first graphitic electrode. In another embodiment, the temperature is increased to allow the more kinetic ions to cause increased oxidation in the first graphitic electrode. The electrochemical cell may be operated at a temperature range of at least 10 C, preferable at least 20 C. The operating temperature may be 30 C, 40 C, 50 C, 60 C, 70 C, 80 C, 90 C or 100 C. Higher or lower operating temperatures may be used. The optimum operating temperature depends on the combination of salt and base used in the process and on the solvent used to suspend them. The higher temperatures facilitate higher concentrations of oxygen-containing salts and base.

Preferably, the electrolyte is not consumed during the process and may be recycled and used in further electrochemical runs. In such embodiments the electrolyte is recovered by means of filtration, at the interface of two immiscible liquids, by centrifugation or by techniques known by those skilled in the art.

Thereby, analysis of the graphene material produced by the process is routinely conducted by means of Raman spectroscopy.

Raman spectroscopy of graphite has been performed for more than 40 years and it recently has been extended to single-layer graphene, its few-layer counterparts and to graphene oxide and few-layer graphene oxide.

The Raman spectrum of all graphitic materials such as graphite, graphene and carbon nanotubes is characterized by two main peaks: The D peak which is located at around 1350 cm⁻¹. This is a first order Raman peak which lies far from the Γ point of the Brillouin zone and as such require defects (or sp³ material) within the basal plane of the graphite for its activation. The G peak is located at around the 1580 cm⁻¹ and is associated with the stretching of all sp2 rings and chains and corresponds to a phonon at the Γ point of the Brillouin zone. The 2D peak is an overtone, i.e. the second order of the D peak and is activated through a double-resonant process. In pristine graphene the width, and not the position, of the 2D peak can be used to unambiguously prove layer thickness. The position may vary due to factors such doping or strain. For pristine graphene, the D peak is absent as there are no defects. The G and 2D peaks are both sharp and the ratio of their intensity (hereby denoted I(G/2D) is 1:4, that is, the intensity of the 2D is nearly four times as intense as the G peak.

The produced graphene material was also characterized by atomic force microscopy in tapping mode as well as by optical microscopy to determine contrast levels. The former technique gives height thickness measurements to prove atomically thin layer thickness while the latter can also provide quantitative information from the optical contrast the flakes provides when dispersion is drop-casted on a silicon substrate with a carefully chosen oxide layer. The term “graphene ” is typically referred to when the graphene flake is around 1 nm thickness but we refer to “graphene” as an umbrella term for both monolayer and few-layer (few nanometer thickness) graphene oxide flakes. The thickness of the flakes produced may vary from 1 nm to 100 nm, but preferentially will be less than 100 nm, more preferentially less than 50 nm and more preferentially under 5 nm. Most preferably the thickness of the material produced is predominantly monolayer.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Without further elaboration, it is believed that the above description has adequately enabled the present invention. The following examples are, therefore, to be construed as merely illustrative, and not limitative of the remainder of the disclosure in any way whatsoever. The publications cited herein are hereby incorporated by reference in their entirety.

In example 1, a nitrate salt (cation: sodium) was used in water with the base being potassium hydroxide. The solution was stirred for approximately 10 minutes to dissolve the salt and base in the water. Subsequently two graphite rods were inserted as electrodes. A voltage of 10V was applied between the two electrodes. The process was stopped after 30 minutes and 0.1 grams of powder was recovered after filtration. The powder was suspended by gently shaking in n-methyl pyrrolidone, and 1 mL was drop-casted onto a Si:SiO₂ substrate for further characterization. The optical image of the material on the oxidized silicon substrate is shown in FIG. 1. The Raman spectrum of the material is shown in FIG. 2.

In example 2, a persulfate salt was used in water with the base being sodium hydroxide. The process run for 1 hour and 0.3 grams of material was recovered after filtration. The Raman spectrum of the material is presented in FIG. 4.

It is to be noted that, the Raman spectrum is characterized by two broad peaks centered around 1350 cm⁻¹ and 1580 cm⁻¹, the D and G peaks, respectively. The second-order peaks, the 2D are heavily quenched as the functionalization of graphene's basal plane results in the suppression of the double-resonant process. This is an indication of preparation of graphene material with functionalization.

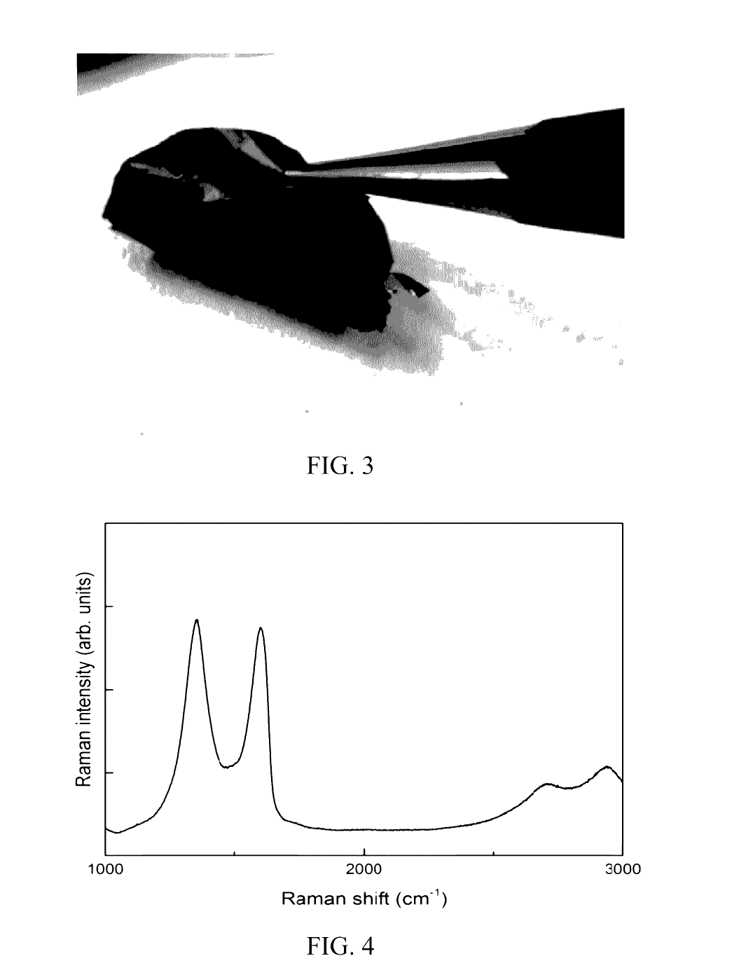

The material was then mixed with n-methyl pyrrolidone and shaken. Small amounts of graphene dispersion was then drop-casted on a silicon wafer covered with 290 nm oxide. Tapping mode AFM reveals that the flakes have thickness of one single atomic layer of graphene as showing in FIG. 2. Moreover 90% of the flakes imaged have this thickness which is favourable for application where graphene thin-film assembly is required. To determine oxygen content of the graphene paper was prepared by suspending the powder in water and mildly sonicating for 10 minutes. The material was then pushed through appropriate membranes to prepare free-standing GO papers as illustrated in FIG. 3. It should be noted that the material had the characteristic mechanical strength and flexibility of graphene paper paper. The SEM of the graphene paper shows characteristics ripples and folds associated with graphene paper. The oxygen content was determined to be under 10 at %

All of the features disclosed in this specification may be combined in any combination. Each feature disclosed in this specification may be replaced by an alternative feature serving the same, equivalent, or similar purpose.

Thus, unless expressly stated otherwise, each feature disclosed is only an example of a generic series of equivalent or similar features.

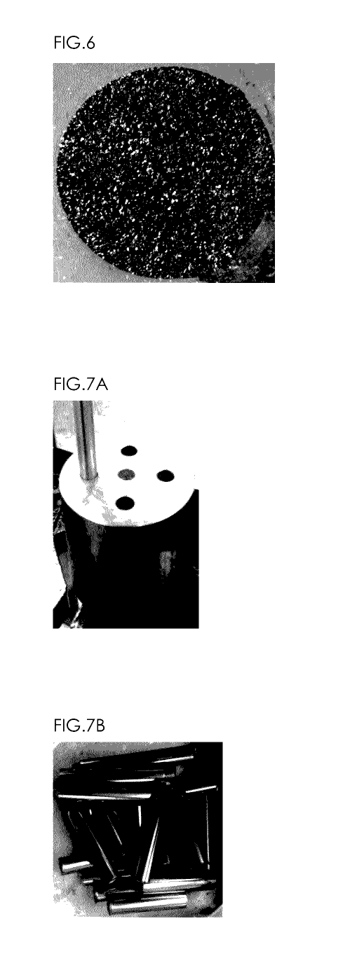

Referring to FIGS. 6 to 11, a method of making graphene powders by electrochemical exfoliating graphite according to a preferred embodiment of the present invention comprises steps of:

A. Fabricating a plurality of graphene rods which includes sub steps of:

a1. Mixing vein graphite with polymer binder, as shown in FIGS. 6A and 6B;

a2. Compressing with a mould under 12 tn pressure to prepare the plurality of graphite rods, as illustrated in FIGS. 7A and 7B;

a3. Annealing at 500 C to graphitize remove the polymer binder from the plurality of graphite rods, as shown in FIG. 8;

B. Electrochemical exfoliating the plurality of graphite rods which includes sub steps of:

b1. Mounting electrodes on plural chips, as illustrated in FIG. 9, wherein up to 60 graphite rods on per batch;

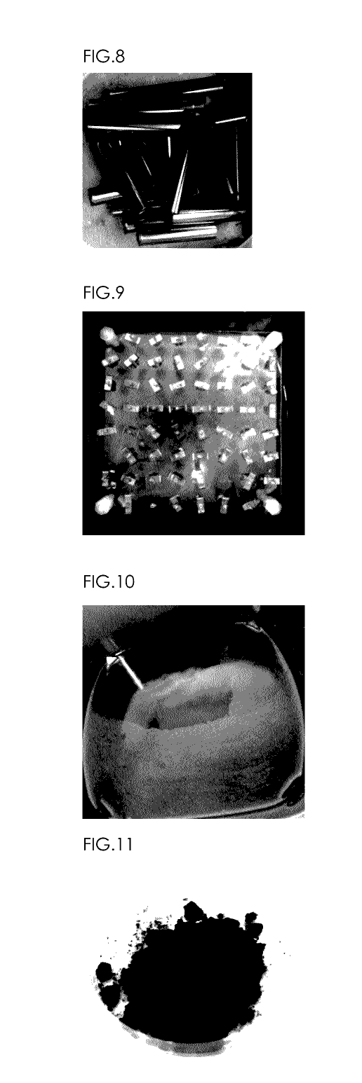

b2. Adding electrolyte, i.e., 0.1M Na SO₄ and applying 10V between the plurality of graphite rods and a conductive counter-electrode on the plural chips for 1 hour, as shown in FIG. 10;

b3. Filtering and repeatedly washing powders on the plurality of graphite rods with water and IPA, and then drying the powders, as shown in FIG. 11, thus producing graphene powders.

From the above description, one skilled in the art can easily ascertain the essential characteristics of the present invention, and without departing from the spirit and scope thereof, can make various changes and modifications of the invention to adapt it to various usages and conditions. Thus, other embodiments are also within the scope of the following claims.

What is claimed is:

1. A method of making graphene powders by electrochemical exfoliating graphite comprising steps of:
A. Fabricating a plurality of graphite rods which includes sub steps of:
a1. Mixing vein graphite with polymer binder;
a2. Compressing with a mould to prepare the plurality of graphite rods;
a3. Annealing at 500 C to graphitize remove the polymer binder from the plurality of graphite rods;
B. Electrochemical exfoliating the plurality of graphite rods which includes sub steps of:
b1. Mounting electrodes on plural chips;
b2. Adding electrolyte and applying 10V between the plurality of graphite rods and conductive counter-electrode on the plural chips for 1 hour;
b3. Heating the electrolyte to between 20-80 C.
b4. Filtering and repeatedly washing powders on the plurality of graphite rods with water and IPA, and then drying the powders, thus producing graphene powders.

2. The method of making the graphene powders by electrochemical exfoliating the graphite as claimed in claim 1, wherein in a sub step of a2, the plurality of graphite rods is compressing with the mould under 12 tn pressure.

3. The method of making the graphene powders by electrochemical exfoliating the graphite as claimed in claim 1, wherein in a sub step of b1, up to 60 graphite rods are arranged per batch.

4. The method of making the graphene powders by electrochemical exfoliating the graphite as claimed in claim 1, wherein in a sub step of b2, the electrolyte is selected from of an inorganic salts of which the anion is:
C1. S2O8
C2. SO4
C3. NO3.

4. The method of making the graphene powders by electrochemical exfoliating the graphite as claimed in claim 1, wherein in a sub step of b2, the electrolyte is selected from of an inorganic salts of which the cation is:
D1. Na
D2. NH3
D3. H
D4. Cu and Zn.

5. The method of making the graphene powders by electrochemical exfoliating the graphite as claimed in claim 1, wherein in a sub step of b1, up to 60 graphite rods are arranged per batch.

6. A method according to claim 1 wherein the monolayer yield is more than 90% by number of flakes.
